(19) United States
(12) Patent Application Publication
(10) Pub. No.: US 2013/0266774 A1
(43) Pub. Date: Oct. 10, 2013

(54) PACKAGE STRUCTURE AND PACKAGING METHOD

(71) Applicants: Pinyen Lin, Yangmei City (TW); Yu-Fu Kang, Yangmei City (TW)

(72) Inventors: Pinyen Lin, Yangmei City (TW); Yu-Fu Kang, Yangmei City (TW)

(73) Assignee: TOUCH MICRO-SYSTEM TECHNOLOGY CORP., Yangmei City (TW)

(21) Appl. No.: 13/491,024

(22) Filed: Jun. 7, 2012

(30) Foreign Application Priority Data
Apr. 10, 2012 (TW) 101112600

(51) Int. Cl. B32B 3/08; C09J 5/02

(52) U.S. Cl. 428/189; 428/192; 156/324.4

(57) ABSTRACT

A package structure and a packaging method for manufacturing the package structure are provided. The package structure comprises a cover wafer, a device wafer and a bonding material. The cover wafer has an optical element, and a surface of the cover wafer is defined with a height difference that is greater than 20 micrometers. The bonding material has a width and continuously surrounds the optical device, and is disposed between the cover wafer and the device wafer, in which the width is between 10 micrometers and 150 micrometers. The bonding material hermetically bonds the cover wafer and the device wafer to make a leakage rate of the package structure less than 5e⁻⁸ atm-cc/sec.

This application claims priority to Taiwan Patent Application No. 101112600 filed on Apr. 10, 2012.

### CROSS-REFERENCES TO RELATED APPLICATIONS

Not applicable.

### BACKGROUND OF THE INVENTION

1. Field of the Invention

The present invention relates to a package structure, and more particularly, to a package structure with a good hermetic effect.

2. Descriptions of the Related Art

The packaging process is known as the most important back-end process in the manufacturing process of semiconductor components or microelectromechanical (MEM) components. The yield rate of the packaging process determines the quality of the semiconductor components or the MEM components. Meanwhile, the size of the package structure is a key factor for miniaturization of the chip. Currently, most wafers are packaged by disposing a bonding material on wafers through screen printing or through coating.

In the screen printing process, a screen printing adhesive flows through holes in a continuous closed path formed on a screen so that adhesive dots are formed on a bonding surface of a wafer. When an upper wafer and a lower wafer are to be bonded together, the adhesive dots will flow to join with each other so that a continuous closed path is formed to hermetically seal the package structure. However, due to limitations of properties of the screen and materials, it is often impossible for the package structure to achieve a desired processing precision; that is, the adhesive line is often formed to have an excessive width which hinders miniaturization of the overall dimensions of the package structure. Moreover, the screen printing process results in the formation of gaps between the wafers. Therefore, there are still many shortcomings to be overcome for the screen printing process.

If a coating process, for example, a spin coating process, is used instead of packaging, it is impossible to selectively coat the bonding material to specific sites for a wafer surface with a height difference. The bonding material tends to be coated nonuniformly to pollute components on the wafer, which causes damage or failure of the components. Therefore, not all packaging structures can adopt the coating process. In another example, after a metal material for bonding is evaporated or sputtered, etching must be made on portions where the coating is not needed, and this tends to damage optical or MEM chips on the wafer surface.

Additionally, U.S. Pat. No. 7,789,287 disclosed a bonding method, which can impart a desired bonding strength to a semiconductor chip at a low temperature. This patent also disclosed that ultrasonic vibrations may be additionally used during the bonding process to make the bonding stronger. However, the ultrasonic vibrations tend to cause damage to the MEM components or optical components of the wafer and the bonding method disclosed therein cannot provide a sealed package. As a result, operational components inside the package structure are still liable to pollution.

Accordingly, an urgent need exists in the art to provide a package structure and a packaging method of producing the same, which can provide a desired hermetic effect so that components inside the package structure operate in a space free of pollution.

### SUMMARY OF THE INVENTION

An objective of the present invention is to provide a package structure in which a bonding material is disposed continuously in an annular form between a cover wafer and a device wafer to provide a desired hermetic effect.

To achieve the aforesaid objective, the present invention provides a package structure, which comprises a cover wafer, a device wafer and a bonding material. The cover wafer has an optical element. The surface of the cover wafer is defined with a height difference which is greater than 20 micrometers. The bonding material has a width and continuously surrounds the optical device, and is disposed between the cover wafer and the device wafer.

The width is between 10 micrometers and 150 micrometers. The bonding material hermetically bonds the cover wafer and the device wafer to make a leakage rate of the package structure less than 5e⁻⁸ atm-cc/sec.

To achieve the aforesaid objective, the present invention further provides a packaging method of producing the aforesaid package structure. The packaging method comprises following steps: providing a cover wafer with a surface that has a height difference greater than 20 micrometers; providing a device wafer; and coating a bonding material continuously in an annular form between the cover wafer and the device wafer to provide a package structure with a leakage rate less than 5e⁻⁸ atm-cc/sec, in which the bonding material has a width ranging between 50 micrometers and 100 micrometers.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a cross-sectional view of a package structure according to an embodiment of the present invention;

FIG. 2 is a top view of the package structure of the present invention in a manufacturing process;

FIG. 3 is a cross-sectional view of the package structure of FIG. 2 that is taken along a line A-A′ during the manufacturing process; and

FIG. 4 is another top view of the package structure shown in FIG. 2 in the manufacturing process.

### DESCRIPTION OF THE PREFERRED EMBODIMENT

In the following description, the present invention will be explained with reference to embodiments thereof. However, description of these embodiments is only intended to illustrate the technical disclosures, objectives and effects of the present invention, but not to limit the present invention. It should be appreciated that in the following embodiments and the attached drawings, elements unrelated to the present invention are omitted from depiction; and sizes of and dimensional relationships among individual elements in the attached drawings are illustrated only for ease of understanding, but not to limit the actual scale and sizes.

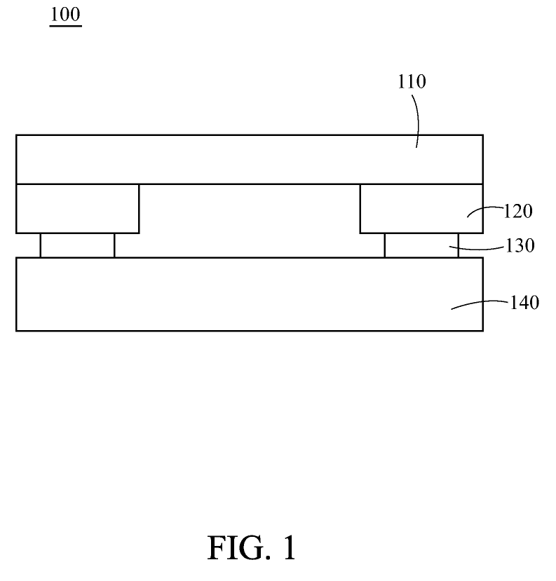

FIG. 1 illustrates a cross-sectional view of a package structure 100 according to an embodiment of the present invention. As shown, the package structure 100 comprises a cover wafer 110, an interposer 120, a bonding material 130 and a device wafer 140. The cover wafer 110 has an optical element (not shown) which, in this embodiment, is made of reflective films plated on two sides of the cover wafer 110. It shall be appreciated that in other embodiments of the present invention, the optical element of the cover wafer may also be a lens instead and the cover wafer may also have other optical elements or microelectromechanical (MEM) elements.

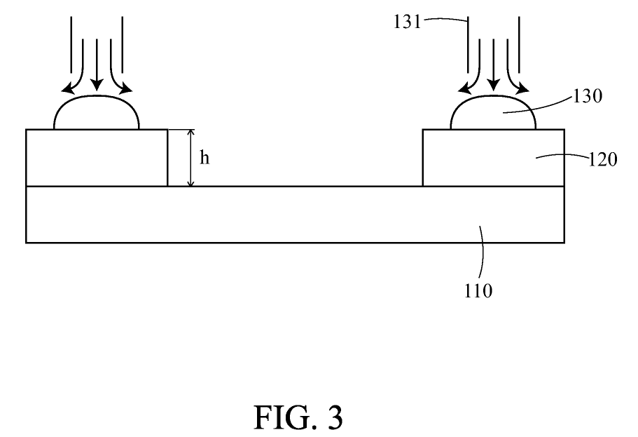

The interposer 120 is disposed continuously in an annular form on a surface of the cover wafer 120 to define a height difference h (as shown in FIG. 3) on the surface of the cover wafer 120.

The device wafer 140 has an operational element disposed thereon which, in this embodiment, is an MEM element (not shown). However, in other embodiments of the present invention, the operational element of the device wafer may also be an optical element or the device wafer itself may be an optical chip or an MEM chip.

In this embodiment, the bonding material 130 has a width d smaller than that of the interposer 120 and continuously and uniformly surrounds the optical element. The bonding material 130 is disposed on the interposer 120. Thus, the bonding material 130 is located between the cover wafer 110 and the device wafer 140 to bond them together so that a closed path is formed by the bonding material 130 between the cover wafer 110 and the device wafer 140. This makes a leakage rate of the package structure 100 less than 5e⁻⁸ atm-cc/sec. It is worth noting that the width of the bonding material 130 is not limited to be smaller than the width of the interposer 120, but may also be equal to the width of the interposer 120. However, it is likely that the width of the bonding material 130 will increase when the wafers are bonded, so to prevent pollution of the optical element or the MEM element due to overflow of the bonding material 130 out of the interposer 120, the width of the bonding material 130 is preferred to be smaller than the width of the interposer 120 and an appropriate force is used to assist in bonding of the wafers to precisely control the width of the bonding material 130.

The width of the bonding material of the present invention ranges approximately between 10 micrometers (μm) and 150 μm. The bonding material is made of a colloid mixed with a nano material such as metal or semiconductor particles. The colloid serves as a solvent and has a viscosity of about 1 cps to 1000 cps. The metal or semiconductor particles have a particle size of less than 3 μm to prevent blockage of a nozzle. The material of the colloid may include 2,2,4-trimethyl-1,3-pentanediol monoisobutyrate, terpineol, pine oil, butyl carbitol acetate, butyl carbitol, or carbitol. Additionally, the metal may be Aurum (Au), Stannum (Sn), Indium (In), Silver (Ag), Copper (Cu), Germanium (Ge), Silicon (Si), Au—Sn or Sn—Ag—Cu, or metal nanoparticles such as nano Au, nano Ag or nano Cu.

In this embodiment, by forming the interposer 120 and the bonding material 130 continuously in an annular form, the operational element of the device wafer 140 can be sealed therein; and the height difference h in the package structure 100 provides a space for the operation of the operational element of the device wafer 140. As a result, the operational element can not operate if the cover wafer 110 and the device wafer 140 are bonded together directly. Furthermore, because the package structure 100 is sealed by the bonding material 130 disposed in an annular form between the cover wafer 110 and the device wafer 140, environmental pollution to the operational element can be prevented.

Hereinbelow, a packaging method for producing the package structure 100 of the aforesaid embodiment will be further described. It shall be appreciated that because the packaging structure is used to produce the package structure 100, relevant elements and choices of materials thereof will not be described herein again.

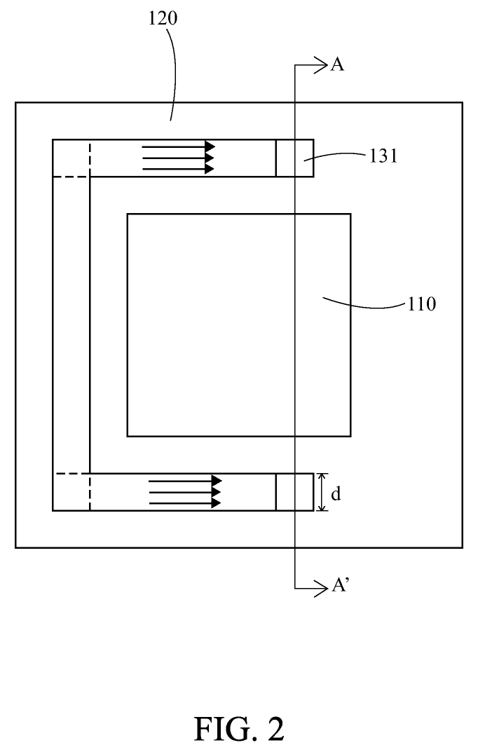

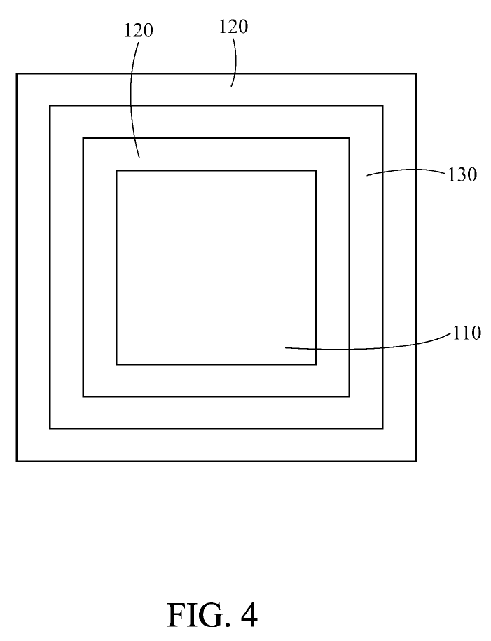

With reference to FIGS. 2, 3 and 4 together, firstly a cover wafer 110 with a height difference greater than 20 μm on a surface thereof is provided, and an interposer 120 is disposed on the surface of the cover wafer 110. Then, through a nozzle 131, a bonding material 130 is continuously coated on a surface of the interposer 130 above the cover wafer 110 to surround an optical element. A width d (ranging between 50 μm and 100 μm) of the bonding material 130 is smaller than a width of the interposer 120. FIG. 2 is a top view of the package structure during the coating process, while FIG. 3 is a cross-sectional view of the package structure shown in FIG. 2 that is taken along a line A-A′. FIG. 4 is a top view of the package structure after the coating process is completed. Next, a device wafer 140 is covered. Now, the bonding material 130 is disposed between the interposer 130 on the cover wafer 110 and the device wafer 140.

After the bonding material 130 is coated continuously in an annular form between the cover wafer 110 and the device wafer 140, an annealing step is carried out. The annealing step is carried out at a temperature between 80° C. and 300° C. to gasify compositions of the bonding material 130 that may affect the vacuum sealing, with only the metal or semiconductor materials left. Then, the metal or semiconductor materials in the bonding material 130 between the cover wafer 110 and the device wafer 140 diffuse into each other or form an alloy material. Thus, a wafer-level packaging process is achieved to satisfy the requirements for hermetic packaging. In this way, a package structure 100 with a leakage rate less than 5e⁻⁸ atm-cc/sec is obtained. It shall be appreciated that in addition to the aforesaid annealing process, a plasma process, a physical process or a chemical process may also be adopted by those skilled in the art in other embodiments to selectively remove non-metal or non-semiconductor compositions from the bonding material.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A package structure comprising:
a cover wafer having an optical element, and a surface of the cover wafer being defined with a height difference which is greater than 20 micrometer;
a device wafer; and
a bonding material having a width, continuously surrounding the optical device and being disposed between the cover wafer and the device wafer, in which the width is between 10 micrometer and 150 micrometer;
wherein the bonding material hermetically bonds the cover wafer and the device wafer to make a leakage rate of the package structure less than 5e⁻⁸ atm-cc/sec.

2. The package structure as claimed in claim 1, further comprising an interposer which continuously surrounds the surface of the cover wafer to define the height difference.

3. The package structure as claimed in claim 2, wherein the bonding material is disposed on the interposer.

4. The package structure as claimed in claim 1, wherein the bonding material comprises a colloid with a metal or a colloid with a semiconductor.

5. The package structure as claimed in claim 4, wherein the material of the bonding material is selected from a group consisting of Aurum (Au), Stannum (Sn), Indium (In), Silver (Ag), Copper (Cu), Germanium (Ge), Silicon (Si), Au—Sn or Sn—Ag—Cu.

6. A packaging method, comprising:
providing a cover wafer with a surface having a height difference which is greater than 20 micrometer;
providing a device wafer; and
coating a bonding material continuously in an annular form between the cover wafer and the device wafer to provide a package structure with a leakage rate less than 5e⁻⁸ atm-cc/sec, in which the bonding material has a width ranging between 50 micrometer and 100 micrometer.

7. The packaging method as claimed in claim 6, further comprising an annealing step after coating the bonding material in an annular form between the cover wafer and the device wafer.

8. The packaging method as claimed in claim 7, wherein the annealing step is carried out at a temperature between 80° C. and 300° C.

9. The packaging method as claimed in claim 8, further comprising a wafer-level packaging process for bonding the cover wafer and the device wafer.

10. The packaging method as claimed in claim 6, wherein the bonding material comprises a colloid with a metal or a colloid with a semiconductor.

11. The packaging method as claimed in claim 10, wherein the material of the bonding material is selected from a group consisting of Aurum (Au), Stannum (Sn), Indium (In), Silver (Ag), Copper (Cu), Germanium (Ge), Silicon (Si), Au—Sn or Sn—Ag—Cu.
